(19) United States
(12) Patent Application Publication
(10) Pub. No.: US 2008/0259930 A1
(43) Pub. Date: Oct. 23, 2008

(54) Message Flow Model of Interactions Between Distributed Services

(76) Inventors: Simon K. Johnston, Siler City, NC (US); Kevin E. Kelly, Raleigh, NC (US); Jan J. Kratky, Raleigh, NC (US); Steven K. Speicher, Apex, NC (US)

Correspondence Address: LAW OFFICE OF JIM BOICE, 3839 BEE CAVE ROAD, SUITE 201, WEST LAKE HILLS, TX, 78746, US

(21) Appl. No.: 11/737,883

(22) Filed: Apr. 20, 2007

(51) Int. Cl. H04L 12/56

(52) U.S. Cl. 370/395.2

(57) ABSTRACT

A computer-implementable method, system and computer-usable medium for defining a message flow model of interactions between distributed services are presented. In a preferred embodiment, the method includes the steps of: capturing unidirectional network-level message traffic between services in a network; identifying service end-points from information obtained from the uni-directional network-level message traffic; identifying message interactions of captured uni-directional network-level message traffic between identified service end-points; applying formal and informal interface definitions to the captured unidirectional network-level message traffic; categorizing each captured unidirectional network-level message traffic as being a public network-level message traffic or a private network-level message traffic; filtering the captured uni-directional network-level message traffic to filter out any formally defined captured uni-directional network-level message traffic; correlating message exchanges for filtered uni-directional network-level message traffic to identify a relationship between correlated message exchanges; and analyzing the network according to identified relationships between correlated message exchanges.

### BACKGROUND OF THE INVENTION

The present invention relates in general to the field of computers and similar technologies, and in particular to software utilized in this field. Still more particularly, the present disclosure relates to analyzing interactions between distributed services in a network to create an activity based model of the network.

During the development of distributed systems, it is difficult to identify functionality of different aspects of the network. This difficulty stems from the nature of the system as it has been deployed, and specifically the relationship between the actual behavior and the intended design. As business applications become more and more reliant upon Service Oriented Architectures (SOA), and are therefore fundamentally developed from a set of independent and distributed services running on heterogeneous platforms using a variety of communication protocols, the ability to understand systems behavior becomes far more difficult. It is often the case that such systems begin to exhibit emergent behavior, which is complex behavior that was not anticipated from the study of the simpler behavior of the constituent services. Analyzing such systems can therefore be prohibitively complex.

### SUMMARY OF THE INVENTION

To address the problem described above, presently disclosed is a computer-implementable method, system and computer-usable medium for defining a message flow model of interactions between distributed services. In a preferred embodiment, the method includes the steps of: capturing uni-directional network-level message traffic between services in a network; identifying service end-points from information obtained from the unidirectional network-level message traffic; identifying message interactions of captured uni-directional network-level message traffic between identified service end-points; applying formal and informal interface definitions to the captured uni-directional network-level message traffic; categorizing each captured unidirectional network-level message traffic as being a public network-level message traffic or a private network-level message traffic; filtering the captured unidirectional network-level message traffic to filter out any formally defined captured uni-directional network-level message traffic; correlating message exchanges for filtered unidirectional network-level message traffic to identify a relationship between correlated message exchanges; and analyzing the network according to identified relationships between correlated message exchanges.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1-3 depict a small network having an exemplary order processing service whose message flow is modeled in accordance with the present invention's steps for examining and analyzing message characteristics to and from the order processing service;

FIG. 4 is a flow-chart of exemplary steps taken to analyze message flow in a network;

FIG. 5 depicts an exemplary computer in which the present invention may be implemented;

FIG. 6 illustrates a Unified Modeling Language (UML) class used to illustrate message ambiguity in a standard UML class;

FIG. 7 depicts a primary services class described by UML;

FIG. 8 illustrates a difference between specification and service depiction in accordance with the presently presented network model;

FIG. 9 depicts an ordering service;

FIG. 10 illustrates an observed message relationship between two services;

FIG. 11 depicts an observed message relationship among three services;

FIG. 12 is a diagram that demonstrates a set of behavioral elements between services;

FIG. 13 depicts an encapsulated process element;

FIG. 14 illustrates a series of messages between network elements;

FIG. 15 depicts a composite illustration of newly-defined relationships between network elements in accordance with the present invention;

FIG. 16 illustrates two services whose functionality has been described in accordance with the present invention;

FIG. 17 depicts a message relationship between two service elements; and

FIG. 18 illustrates a generic model used to describe any element in a network.

### DETAILED DESCRIPTION OF THE PREFERRED EMBODIMENT

Presented herein is a novel method for generating a behavioral model of a network of software services. This new model acts as an intermediary between highly granular trace data (found in nodes) and the high level software component view (of an entire network). Thus, presented herein is a Message Flow Model that is based on uni-directional message exchanges between services, which is constructed from observational trace data and/or informal trace data (e.g., written documentation). The model allows for reasoning that can be used to augment the model with relationships such as request-response or request-response-fault as they are identified.

A key advantage of the presently presented model is that it allows the description of a service-oriented system in a clear and coherent manner. Note that the specifics of message types (schema) and body expression are not necessary to the creation of the model. Rather, the presently presented model focuses on capturing the message interactions between network services.

Before presenting details of how the presently presented network model is created, a simple example of one component of the present invention is presented in FIGS. 1-3, which presents interactions between three sets of services in a network 100, specifically Purchasing service 102 (which takes in purchase orders), OrderProcessing service 104 (which processes these orders), Customers service 106 (which provides a customer database), and Shipping service 108 (which ships the processed orders to the appropriate customer) to execute the placement of an order for goods. Note that, for exemplary purposes, it is assumed that a complete picture of interactions between the services is not available under Web Services Description Language (WSDL) or some similar Interface Definition Language (IDL), since the services shown may be hosted by another party, are not described by any standard interface definition language (such as WSDL), are only partially described by WSDL, or utilize processes and interactions that are hidden from the public.

For exemplary purposes, assume that the model shown in FIG. 1 was generated from an analysis of messages sent between the services (102, 104, 106, 108) collaborating in the solution. Note that the use of dashed lines for the services indicates that a detailed relationship with other services is not yet determined using the presently presented method, and thus dashed lines merely describe a specification, rather than a complete service. Note also that messages are denoted by lines between message connectors that have a “>” within the connectors to denote the directionality of the message. Each line is uni-directional; therefore a request-response pair is denoted as two distinct lines. For example, as shown in FIG. 1, a CustomerRq message is a request to and the Customer message is a response from Customers service 106; thus, there is no modeling difference between an asynchronous response and a synchronous return type. The model also denotes the “type” of the message with a textual annotation on the line, but the actual definition of the message structure is deferred to another standard language.

The model shown in FIG. 1 can then be further refined. By looking at the interface definition language for the OrderProcessing service 104, observations can confirm that the Order and OrderAck messages are not independent, such that the acknowledgement message is the return from a synchronous operation. This relationship between messages is denoted by a line shown inside OrderProcessing service 104.

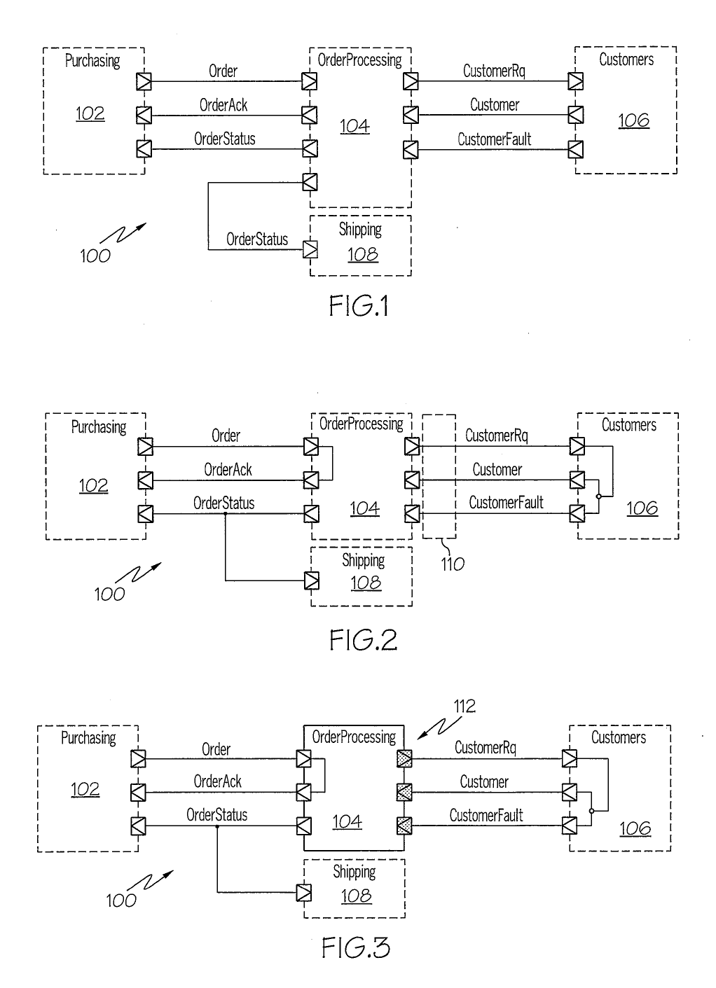

It is then discovered that the OrderStatus message is sent back to the Purchasing service 102 and also to the third party Shipping service 108 as a single logical unit of work. To denote this, the lines for OrderStatus coming away from OrderProcessing service 104 are joined together to show a single message leaving the OrderProcessing service 104 and arriving at two separate services (Purchasing service 102 and Shipping service 108), as depicted in FIG. 2. The filled “dot” that joins the lines represents an “AND” semantic, whereas the open dot joining the lines inside the Customer service 106 represents an “OR” semantic.

In this case, through observation of the Customers service 106, a determination can be made that when a CustomerRq message arrives at Customers service 106, Customers service 106 always responds with either the Customer message or the CustomerFault message. Note that whether the model is refined manually (i.e., by a network engineer reading documentation, calling a person who owns the Customers service 106, etc.) or by some tool analyzing the trace (i.e., WSDL) is irrelevant to creating the model.

Continuing with the example, assume that a discovery is made (either manually or automatically) that, when the interface definition for OrderProcessing service 104 is re-examined, it is apparent that neither the CustomerRq or Customer interactions appear on a published interface 110 (e.g., WSDL), because CustomerRq and Customer interactions are internal to the logic of the Customers service 106. Thus, the appropriate nodes 112 in OrderProcessing service 104 are colored grey to denote this, as shown in FIG. 3. The identification of this kind of communication aids in understanding the dependencies between services, dependencies which are not documented independent of the implementation and which can radically affect the ability to reuse or to replace a particular service. Note that OrderProcessing service 104 is now depicted as a solid box, indicating that OrderProcessing service 104 is in fact a defined service, while Purchasing service 102, Customers service 106 and Shipping service 108 are still viewed only as service specifications that are available to OrderProcessing service 104.

In the example shown in FIG. 1-3, a visual representation of the model based on message exchanges is presented. Alternatively, this model may be represented in a textual format, such as:

```
service ordering_trace is
  specification Purchasing is
  message
    Order : out Order;
    OrderAck in Order;
    OrderStatus : in
  Order;
  end;
  specification OrderProcessing is
  message
    Order : in Order;
    OrderAck : out OrderAck;
    OrderStatus : out OrderStatus;
  network
    Order to OrderAck;
  end;
  service OrderProcessing implements OrderProcessing
  is message
    CustomerRq : out CustomerRq;
    Customer in Customer;
    CustomerFault : in CustomerFault;
  end;
  specification Shipping is
  message
    OrderStatus : in OrderStatus;
  end;
  specification Customers
  is message
    CustomerRq : in CustomerRq;
    Customer out Customer;
    CustomerFault : out
    CustomerFault;
  network
    CustomerRq to Customer or CustomerFault;
  end;
uses
  p : Purchasing;
  op : OrderProcessing;
  sh :
Shipping;
  c :
Customers;
network
  p.Order to op.Order;
  op.OrderAck to p.OrderAck;
  op.OrderStatus to p.OrderStatus and sh.OrderStatus;
  p.CustomerRq to c.CustomerRq;
  c.Customer to p.Customer;
  c.CustomerFault to p.CustomerFault;
end;
```

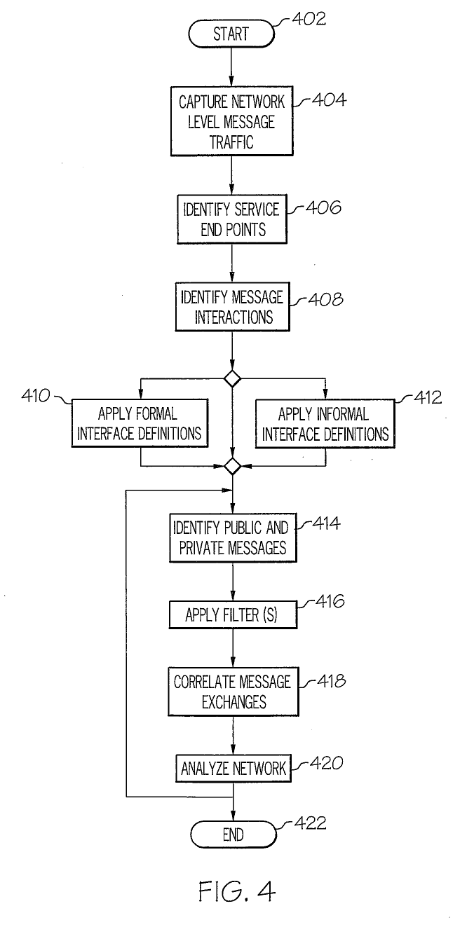

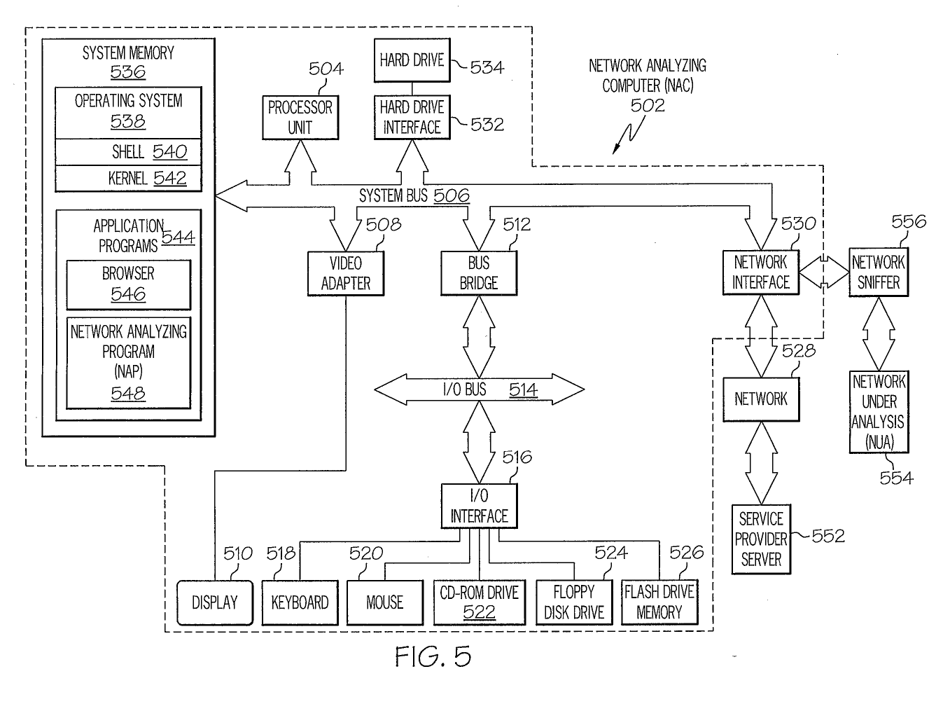

Referring now to FIG. 4, a flow-chart of exemplary steps taken to define a message flow model of interactions between distributed services in a network is presented. After initiator block 402, uni-directional network-level message traffic is captured (block 404). In one embodiment, this message traffic is captured by a network sniffer 556 (shown below in FIG. 5), which is controlled by a network analyzing service, which may utilize a system, including a computer such as Network Analyzing Computer (NAC) 502, as shown below in FIG. 5. Network sniffer 556 monitors traffic between services in a network, such as services 102-108 described above in FIGS. 1-3. Such monitoring includes, but is not limited to, recording header information (including message types, source and target addresses, etc.), recording and analyzing any available WSDL information, recording reactions to particular messages between two or more specific and/or specified services, tracing port, network, and line usage, retrieving written text documentation (human-readable) describing services and interfaces, etc.

As described at block 406, service end-points (e.g., services 102-108) are identified, either through information derived from the network sniffing operation, manually through an examination of available network documentation, or through similar automatic and/or manual methods.

Message interactions are then identified (block 408). These interactions may be generally categorized as “causations,” “correlations,” or “coincidences.” For example, if messages are identified as synchronous messages (e.g., “Request” and “Response”), then their interactions are defined as “causations,” since the “Request” always causes the “Response.” However, messages that are asynchronous messages (e.g., “Login” and “Token”) are classified as “correlations,” since a token may or may not be supplied when a user logs in. Identifying “correlation” messages may be performed by locating a same identifier (e.g., of a user) in both messages. If no consistent pattern or common identifier or other item identifies messages as being “causation” or “correlation” based, then “coincidence” is the default identifier for the messages.

At this point, either formal (block 410) or informal (block 412) interface definitions are applied to the messages that are being analyzed. An example of a formal interface definition is information from a WSDL interface. Examples of informal interface definitions are written operator manuals, text files describing a service and/or network, personal knowledge of a legacy system, etc.

After applying the formal and/or informal interface definitions, messages are identified as being public or private (block 414). A public message is identified as a message between two public service nodes. A private message is identified as a message that either 1) remains within a service node at all times or 2) communicates with a service that is not part of the network being analyzed (and thus is “hidden”).

As shown in block 416, filter(s) are then applied to the messages. That is, in order to methodically analyze messages, only certain types of messages should be analyzed at any one time—usually this is the focus of a problem being determined or the analysis of the behavior of one or more specific services in the network. Thus, any messages with WSDL information can be evaluated by applying a filter that only allows WSDL-enabled messages to be analyzed (block 420). Thereafter, other messages are analyzed according to how they have been identified and defined (such as messages described in a text user-file, etc.) until all messages have been evaluated. By obtaining as many messages for evaluation as feasible, and by building up the network model in a “bottom up” manner, an accurate message flow model of interactions between distributeds services in a network is created, and the process ends at terminator block 422.

With reference now to FIG. 5, there is depicted a block diagram of an exemplary Network Analyzing Computer (NAC) 502, in which the present invention may be utilized. NAC 502 includes a processor unit 504 that is coupled to a system bus 506. A video adapter 508, which drives/supports a display 510, is also coupled to system bus 506. System bus 506 is coupled via a bus bridge 512 to an Input/Output (I/O) bus 514. An I/O interface 516 is coupled to I/O bus 514. I/O interface 516 affords communication with various I/O devices, including a keyboard 518, a mouse 520, a Compact Disk-Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

NAC 502 is able to communicate with a service provider server 552 via a network 528 using a network interface 530, which is coupled to system bus 506. Network 528 may be an external network such as the Internet, or an internal network such as an Ethernet or a Virtual Private Network (VPN). Service provider server 552 may utilize a similar architecture design as that described for NAC 502.

As described above, NAC 502 utilizes a network sniffer 556 to sniff traffic from a Network Under Analysis (NUA) 554. This sniffed traffic forms the basis for a model of NUA 554, as described herein.

A hard drive interface 532 is also coupled to system bus 506. Hard drive interface 532 interfaces with a hard drive 534. In a preferred embodiment, hard drive 534 populates a system memory 536, which is also coupled to system bus 506. Data that populates system memory 536 includes NAC 502's operating system (OS) 538 and application programs 544.

OS 538 includes a shell 540, for providing transparent user access to resources such as application programs 544. Generally, shell 540 is a program that provides an interpreter and an interface between the user and the operating system. More specifically, shell 540 executes commands that are entered into a command line user interface or from a file. Thus, shell 540 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 542) for processing. Note that while shell 540 is a text-based, line-oriented user interface, the present invention will equally well support other user interface modes, such as graphical, voice, gestural, etc.

As depicted, OS 538 also includes kernel 542, which includes lower levels of functionality for OS 538, including providing essential services required by other parts of OS 538 and application programs 544, including memory management, process and task management, disk management, and mouse and keyboard management.

Application programs 544 include a browser 546. Browser 546 includes program modules and instructions enabling a World Wide Web (WWW) client (i.e., NAC 502) to send and receive network messages to the Internet using HyperText Transfer Protocol (HTTP) messaging, thus enabling communication with service provider server 552.

Application programs 544 in NAC 502's system memory also include a Network Analyzing Program (NAP) 548, which includes logic for implementing, preferably via an AOP logic that is included in NAP 548, the steps and processes described herein. In a preferred embodiment, service provider server 552 also has a copy of NAP 548, which may be executed by or downloaded from service provider server 552, as described below. In one embodiment, NAC 502 is able to download NAP 548 from service provider server 552.

The hardware elements depicted in NAC 502 are not intended to be exhaustive, but rather are representative to highlight essential components required by the present invention. For instance, NAC 502 may include alternate memory storage devices such as magnetic cassettes, Digital Versatile Disks (DVDs), Bernoulli cartridges, and the like. These and other variations are intended to be within the spirit and scope of the present invention.

As noted above, NAP 548 can be downloaded to NAC 502 from service provider server 552. This deployment may be performed in an “on demand” basis manner, in which NAP 548 is only deployed when needed by NAC 502. Note further that, in another preferred embodiment of the present invention, service provider server 552 performs all of the functions associated with the present invention (including execution of NAP 548), thus freeing NAC 502 from using its resources. In another embodiment, process software for the method so described may be deployed to service provider server 552 by another service provider server (not shown).

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Presented above is a general overview of a novel method and system for defining a message flow model of interactions between distributed services. Presented below is a more detailed description of a preferred embodiment of such a method. Specifically, now described are details of an exemplary process used to describe a model that captures the structural relationships between services and dynamic interactions between them as they enact business processes. The model presented here is particularly useful in the context of Service-Oriented Architectures (SOA). Described herein is a new conceptual model based only upon the sending and receiving of messages as well as a component description language using a “bottom-up” analysis approach. The resulting model can be used as a network model framework or as the basis for a service language—an example of which is used to illustrate the issues presented herein.

While the model generally treats services as black box implementations of service specifications, it does provide both implementation connections and an action language to describe enough of the behavior of a collaborating set of services to facilitate simulation or other reasoning about these services.

While developing both tools and guidance for the modeling and description of SOA solutions it is frequently the case that the current set of technologies used to describe and implement services fall short of being able to completely describe them. Specifically it is hard to model the complete specification of a service, because WSDL only describes the provided interface of a service and ignores the notion of a reciprocal or required interface.

While the analysis of these problems has focused on web services it can be generalized to cover software services as a broader concept and even more broadly to all software components.

WSDL is the most commonly used method for describing the interface to web services, and does so in a typical component/interface manner presenting an interface as a named set of operations. Alternatively, other interface descriptors may be used to perform the function of WSDL as described herein. Examples of other interface forms include, but are not limited to, those used by Java™ interfaces, COBOL copy books, etc.

Simple Object Access Protocol (SOAP) 1.2 introduced the notion of a Message Exchange Pattern (MEP) as either a single unidirectional or combination of messages used commonly for some purpose. WSDL 2.0 codifies and completes the set of MEPs:
In-Only {no faults}
Robust In-Only {message triggers fault}
In-Out {fault replaces message}
In-Optional-Out {message triggers fault}
Out-Only {no faults}
Robust Out-Only {message triggers fault}
Out-In {fault replaces message}
Out-Optional-In {fault replaces message}

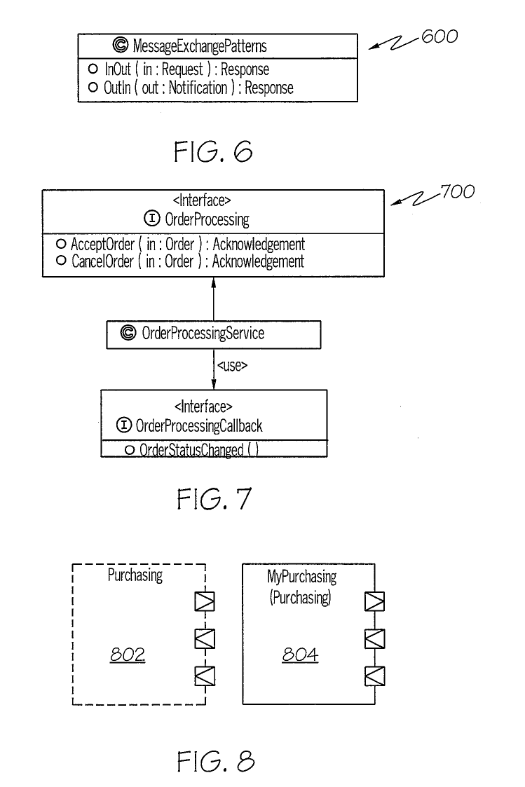

In some cases, is can be difficult to distinguish the in-out case from the out-in case, since most programming languages and design languages tend to see an operation only from the requester's viewpoint. For example, in the Unified Modeling Language (UML) class 602 shown in FIG. 6, operation OutIn may or may not convey the desired meaning intuitively. This leads to specifications which do not express all the dependencies between services. Notifications sent by services tend not to be captured on the specification, and are buried in the implementation as calls out from the service provider to a consumer.

When modeling an interface, it becomes difficult to distinguish the difference between In-Out and Out-In when described as operations. To model this difference in the Unified Modeling Language (UML), the provider is modeled as one interface, while notifications or callback messages are modeled as a second interface. For example, as shown in FIG. 7, a primary service 702 accepts new orders and allows for orders to be canceled.

Thus the complete definition of the service specification actually requires three model elements, which results in extensive overhead. This initial observation leads to a rethinking of the underlying structural elements required to describe a service interface—are classical operations the correct basis? Thus, rather than trying to capture operations as named sets of messages or parameters, a model described herein is expressed in terms of the individual messages. Rather than expressing a set of operations that may be invoked by the sending and receiving of message, a service is specified only in terms of the messages it responds to and which it sends out. This model is therefore expressed in a manner more fine-grained than the MEP in WSDL, thus there is no mismatch in semantics.

Hidden Service Dependencies raises another issue when trying to develop a model that shows the inter-dependencies between services in a solution. Specifically, using typical Web Service standards causes a number of inter-dependencies to be hidden from the model. A service publishes a set of interfaces that it provides to consumers. In some cases (such as the UML example previously shown), this set of interfaces describes the reciprocal interface required to be provided by a consumer. Unfortunately when this service makes calls to another service in the course of its logic, such invocations are not exposed and made public. Publicly exposing such invocations is not required, and it is rarely the case that a service will document the set of other services upon which it relies.

The novel model represented herein describes a Service Oriented Architecture (SOA) solution as a network of messages connections between service instances. The model can be used to describe the implementation within (micro-flow) a service, or service operation, as well as the choreography (macro-flow) of messages between service instances. In this second regard the model has to take into account existing composition and flow languages and specifically Web Services Business Process Execution Language (WS-BPEL), which is often used as a standard choreography language for Web Services.

The presented model also provides a textual and visual syntax. The reason for this is that the visual syntax can be used to create “scenario” diagrams (i.e., only presenting information from the model as appropriate to a user in a context). The use of the visual syntax to present views into the model is useful. The textual syntax is not intended for this purpose, and should capture all details of the model as it is the persistent form of the model.

The structural aspects of the model (definition of the types of messages) corresponds to the use of XML Schema and a subset of WSDL in the web services world. It also provides additional capabilities not found in these standards.

Specification vs. Service Visualization

Note that a service can implement a named service specification, as shown FIG. 8. Purchasing 802 is a service specification that is implemented by the service MyPurchasing 804. Thus, there is a visual distinction between the specification and the service. First, the outline of the service is a solid rather than a dashed line. Second, the service optionally denotes the implemented specifications in parenthesis under the service name. This is a useful graphical distinction, since some composite services will actually reference specifications and not services, thus deferring the implementation choice.

The mechanism by which a service (implementation) is selected to fulfill the role identified by a specification is dependant upon deployment-time configuration. Note that service shown in FIG. 8 may be implemented with other technology. For example, while a service specification can be described using this model, at deployment time a Java implementation is provided for the specification. Thus, the behavior of this Java implementation is entirely opaque as far as the model described herein is concerned.

### Service Composition

An elaboration of the FIGS. 1-3 is now presented. Note that none of the elements in FIGS. 1-3 describes or owns the wiring between the message connectors, so there has to be a containing element. Pseudocode for a service declaration for the services/specifications described in FIGS. 1-3 is:

```
service purchasing is
using
  p : Purchasing;
  o : OrderProcessing;
  s : Shipping;
network
  p.SubmitOrder to o.AcceptOrder;
  o.AcceptOrder to p.OrderAccepted;
  o.OrderStatusChanged to
    p.OrderNotifications and s.OrderStatus;
end;
```

The service shown here is termed an encapsulated service, since it does not implement any particular previous specification, and therefore does not expose any messages for an outside consumer to use. Such a service is often used as the outer container for a system.

The introduction of the keyword network provides a mechanism to connect messages together between the services used internally by the declaration. Each “wire” statement in the network section is directional; it starts at an outbound message connector and terminates at one or more inbound message connectors. Note also that these wires are not named, thus there is no need to reference the wires directly.

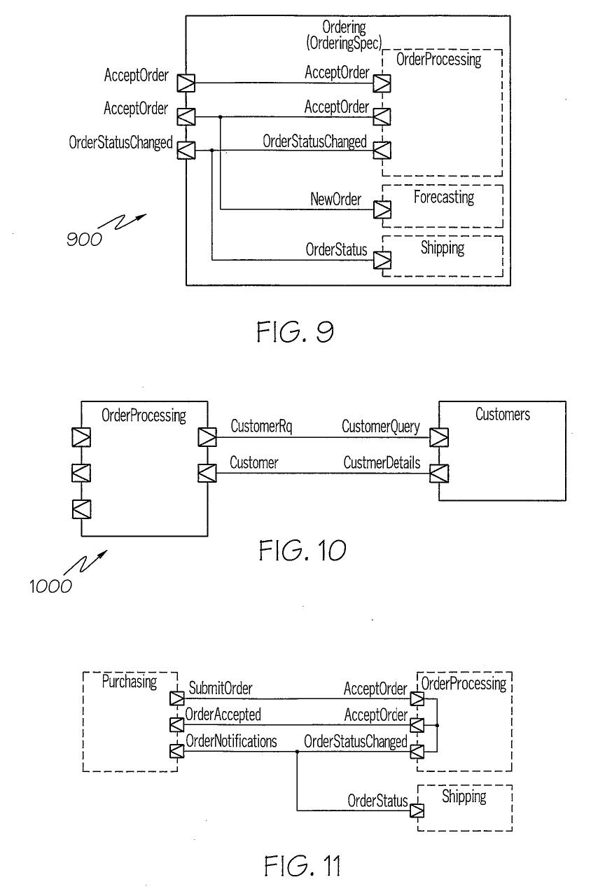

In terms of composite services the model is simple and recursive. A service (not a service specification) may declare a set of services that it uses and then define the network of wires that connect it to these used services. This feature is illustrated in an exemplary manner in the system 900 shown in FIG. 9.

As shown by the service described, “Ordering” implements the specification “OrderingSpec.” This specification (“OrderingSpec”) provides a set of messages and internally relies on the implementation of three service specifications to perform the actual work. The following is the textual form of both the specification and the service itself.

```
specification OrderingSpec is
import schema “http://tempuri.org/ordering”;
messages
  AcceptOrder : in Order,
  AcceptOrder : out Acknowledgement;
  CancelOrder : in Order,
  CancelOrder : out Acknowledgement;
  OrderStatusChanged : out Status;
end;
service Ordering implements OrderingSpec is
uses
  o : OrderProcessing;
  f : Forecasting;
  s : Shipping;
network
  AcceptOrder to o.AcceptOrder;
  o.AcceptOrder to
    AcceptOrder and f.NewOrder;
  o.OrderStatusChanged to
    OrderStatusChanged and s.OrderStatus;
end;
```

Note that the import schema keywords has been added, and that there is no language to describe data or message structures. The presently presented model does not have a type language. Rather, in a preferred embodiment it relies entirely upon Extensible Markup Language (XML) Schema. This line imports all the types in an XML Schema identified by the Uniform Resource Identifier (URI) that follows.

### Implementation Message Connections

In the following example, the hidden dependency issue introduced earlier is addressed. Added is the ability to define messages on a service, which are not exposed through the public specification and are therefore intended to support internal logic. Thus, consider the example system 1000 depicted in FIG. 10. OrderProcessing service in the course of accepting an order needs particular details of a customer, and so makes a call to the Customers service. It makes no sense to add the messages CustomerRq and Customer to the specification for order processing, and so allowance is made for messages to be declared on a service definition for this purpose.

In the visual notation shown in FIG. 10, these service-implementation messages are denoted by a filled shading. In the textual format, the same messages construct is used within in the service declaration that was previously used on specifications.

```
service OrderProcessing ...
uses
  c : Customers;
messages
  CustomerRq : out CustomerQuery;
  Customer : in CustomerDetails;
network
  CustomerRq to c.CustomerQuery;
  c.CustomerDetails to CustomerDetails;
end;
```

Note that the placement of connectors on the visual syntax has no significance, either in order or on which edge they appear.

### Denoting Message Exchanges

Previously described is the fact that the model here does not provide structures, such as operations or direct representations of the message exchange patterns introduced above. It is valuable in many cases, however, to be able to visualize the logical relationships between messages expressed in the presently described model, such as denoting the possible responses for a given request message. It is only possible to describe these relationships on service specifications, and so specify externally perceived behavior—a service has to provide the detailed logic and behavior that implements these described relationships. In this case it is possible to use the network wiring section of the specification to wire message connectors on the inside of the component. This is shown in the example shown as network 1100 in FIG. 11.

As depicted, when Purchasing sends the AcceptOrder message to the OrderProcessing service, the response message is automatically sent back to the client. Note that the OrderStatusChanged notification is also sent as it is also wired to the AcceptOrder pair. Thus, stated textually:

```
specification OrderProcessing ...
network
  AcceptOrder[in] to
    AcceptOrder[out] and OrderStatusChanged;
end;
```

Note that to disambiguate the two messages with the same name, a keyword “in” or “out” in brackets is used after the message name. It is not legal to have two same-named messages without such disambiguation.

### Behavioral Model

Most ADLs do not provide a detailed semantic model for the behavior of the components they describe. And, while it does seem that the structural and behavioral aspects of the service message model should be kept separate one provides little value without the other.

The structural model presented above provides a complete definition of all connections between services; in effect all the messages, paths and dependencies are made public and visible. However, what is missing is the specification of the behavior invoked when a message is received by a service and the processing resulting in messages being sent by a service.

While the goal of the present model is to capture the structure of a collaboration of service completely, the behavior of services is described either partially or completely depending on the need of the developer. The model does not take the place of current implementation technologies and while the creation of services that only contain messages handlers (see below) can describe considerable portions of a process it is expected that the model be able to generate BPEL or some equivalent to describe the overall perceived process.

Behavior is expressed in terms of both the connection patterns as well as the action language expressions attached to message handlers.

### Process Patterns

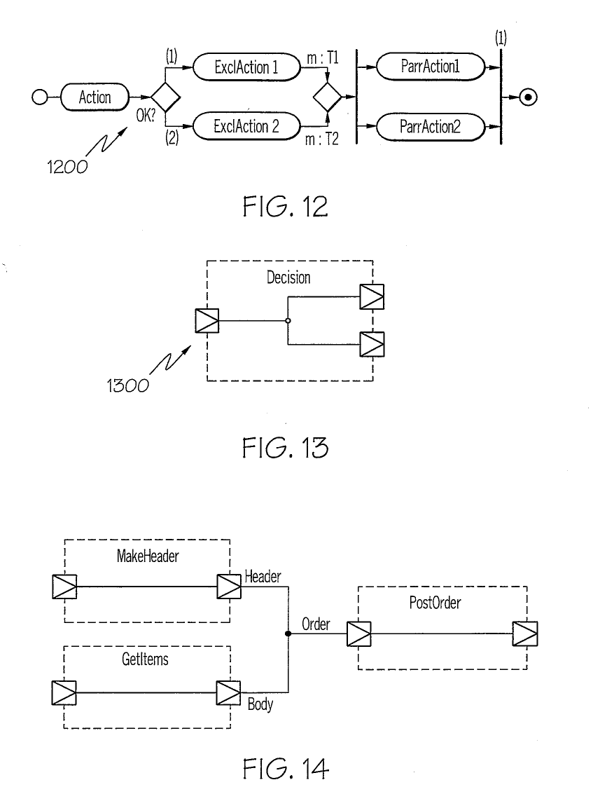

Referring now to FIG. 12, a diagram 1200 demonstrates a set of behavioral elements that can be represented in this model as a combination of structural patterns involving particular configurations of services and connectors.

In particular it is the case that these basic building blocks of a business process diagram (or flow chart or UML Activity) do not require the addition of specialized elements in the model presented here. This means that one will not find a “decision” or “merge” model element yet if the diagram above were taken as input. However, it is a relatively easy operation to map from the process elements to the patterns described in the following text.

First, look at the initial decision point. In most process notations this element has a single input flow, an evaluation expression and two or more exclusive flows leaving it. This is shown in the example with “OK?” as the expression and the value “1” guarding one outbound flow and the value “2” guarding the other.

The simplest mapping from this process element is to introduce a new service that encapsulates the decision, such as process element 1300 shown in FIG. 13. The service specification has a single input with two or more outputs. Note that the logical behavior has been expressed with implementation connections (note the “or” junction). This specification simply says that the input is connected to either one output or the other in a mutually exclusive manner. The service specification for this is shown below. The service itself describes the actual decision expression as a message handler for the input message. The action language introduced here is described as:

```
specification Decision ...
message
  input : in Input;
  out1 : out Output;
  out2 : out Output;
network
  input to out1 or out2;
end;
service IsOK implements Decision ...
process
  on input
    if expression then
      let $out1 := ...
    else
      let $out2 := ...
end;
```

Following the decision, there are two mutually exclusive tasks. These tasks could be on different services, such as the case where these are two operations on the same service. The merge of these exclusive flows is effectively shown as a reverse of the Decision node above. This corresponds to the following service specification (again using an “or” junction). Note that the types of the input flows and output flows do not have to match; the message handler(s) for the service can perform any necessary transformation.

This corresponds to the following specification/service for the merge.

```
specification Merge ...
message
  in1 : in Input;
  in2 : in Input;
  output : out Output;
network
  in1 or in2 to output;
end;
service Merged implements Merge ...
process
  on in1 or in2 to output
    return message( )
end;
```

We have already seen parallel activities in previous examples with the simple use of the “and” junction. This implies that some aspects of the system behavior are modeled within the specifications (the merge, the join) and some by the way in which these services are connected by the enclosing service. The joining of parallel paths is more complex, in the simplest case a junction can be used to join the paths back together. Unfortunately this use of the “and” junction has a very particular meaning which may not be appropriate in many cases; this is best explained using the following example shown in FIG. 14. The type of the message named Order has to contain one top-level element for each of the messages input to the join. Thus, the join will wait for one Header and one Body to arrive and then send the following message to the PostOrder service.

```
<Order>
  <Header>...</Header>
  <Body>...</Body>
</Order>
```

Two cases therefore exist where this default behavior of a junction may be inappropriate.

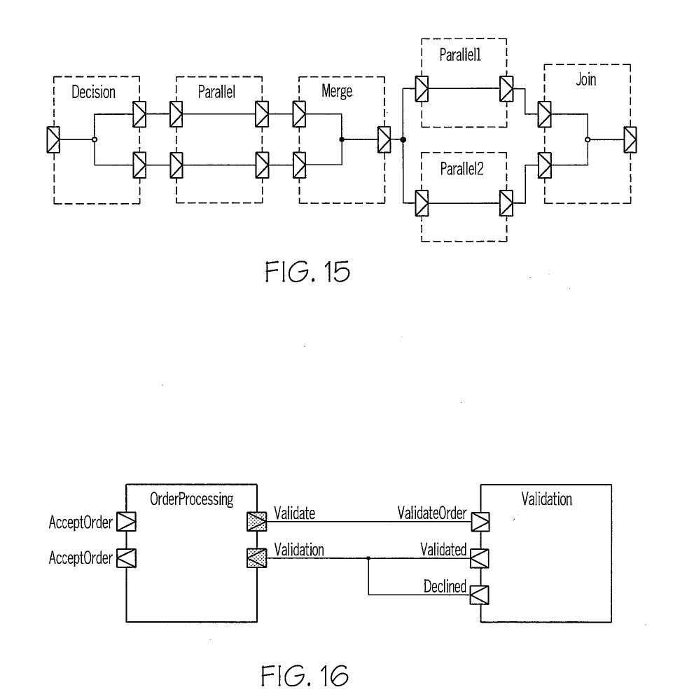

The flow shown in FIG. 15 is therefore the complete specification of the flow introduced herein.

The preferred approach taken to create the network model described herein is to keep the number of primitive elements as small as possible, providing additional capabilities as patterns. These patterns provide common functions used in the connecting of services and the description of behavior acting across services. On the other hand it can be easier for the modeler to be able to distinguish when one of these patterns has been consciously applied as opposed to the case where services naturally end up looking like a decision or a merge. In this case it may be appropriate to introduce visually unique elements.

### Action Language

To describe the processing that occurs within a service on the receipt of messages we need a language that allows us to define such behavior. In the same way that the structural aspects of the language leverage XML Schema for message declarations and allow for the import of WSDL for representation of specifications the action language has been chosen from the XML family-XQuery.

The first step in describing this behavior is to add a process section to the service text. This section contains a series of message handlers, which respond to the receipt of input messages. Each message handler can respond to more than one message, and each handler has an expression describing the conditions under which it is executed. This expression, or sensitivity list (using terminology from the VHDL from which the textual syntax of the model has been derived), can use the logical operators “and”, “or” and “not”. The body of this message handler is expressed in XQuery.

The example shown in text below describes the behavior of the AcceptOrder message handler for the OrderProcessing service, such as shown in FIG. 16.

```
service OrderProcessing implements OP is
message
  Validate : out Order;
  Validation : in ValidationResp;
process
  on AcceptOrder
    let $total := $AcceptOrder/Header/Total
    if $total > 1000 then
      let $Validate = $AcceptOrder
    else
      ...
  on Validation
    if $Validation/state = true( ) then
      ...
    else
      let $AcceptOrder := create_decline_order( )
end;
```

In terms of the XQuery embedded in the handler the messages described in the sensitivity list are available within the handler and act as module variables. However, input messages are only read-only, and as demonstrated in the example above, $AcceptOrder can be assigned from but not assigned to. Conversely the output messages are write-only and can be the target of a let statement as you can see with the $Validate message above. However, in the case that a sensitivity list contains an expression with more than one message, the handler can use the reserved variable “$message” to distinguish which message(s) actually caused the handler to execute. This variable will contain the name of the message which caused the handler to execute.

### Message Connector Characteristics

As the model presented here is intended to be a reasonable alternative to the reliance on WSDL to described services, depending on the needs of the user, it must be able to express at least the kinds of service interfaces commonly developed today.

For example, it is likely that a user would want to be able to denote an input message as being reliably delivered and queued on arrival. This is specified only on the input message. Thus, the output message does not need to denote these attributes, and therefore the attributes are not required to validate the connection between sender and receiver. The reason for this is that the middleware technology is expected to negotiate this connection at runtime when the sender sends an output message, thus allowing a sender to wire to a receiver regardless of their requirements for delivery and with assurance that the message is being transmitted correctly.

To this end it should be possible to extend the description of message connectors with attributes that allow declarative extensions. While this section of the language is currently not completely defined an example approach would be to use the attribute mechanism above, as shown here.

```
specification ApprovalRouter is
messages
  [queued, reliable] NewOrder : in Order;
  Approve : out Order;
  Escalate : out Order;
  ...
```

Or, alternatively, inclusion of XML, allowing the direct integration of existing specifications such as WS-Policy or WS-Security. This is a cumbersome approach but would be entirely appropriate in an all-XML rendering of the model.

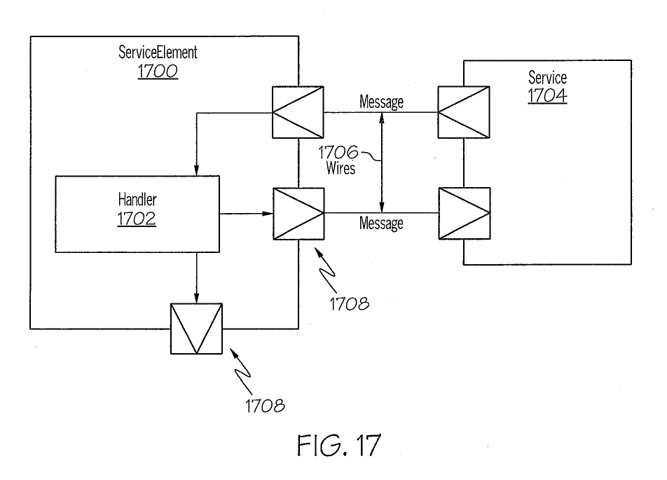

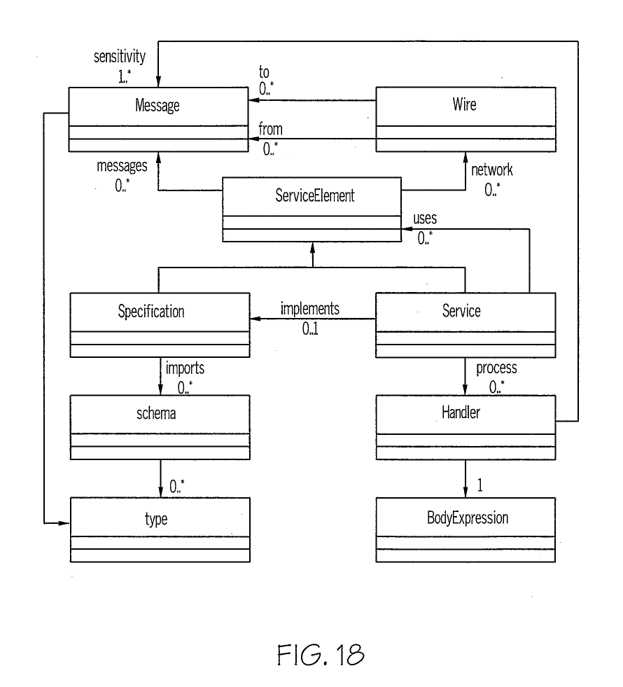

The diagrams shown in FIGS. 17 and 18 represent the logical elements of the model described herein.

As shown in FIG. 17, a ServiceElement 1700 includes a message Handler 1702. When an event (such as a “Service” request shown in FIG. 18 as “Service”) occurs, Handler 1702 implements a BodyExpression (shown in FIG. 18), which denotes that the Handler 1702 has finished handling incoming messages. Note that “Msg.” is a type message that is defined by a schema in a specification. Thus, when a ServiceElement 1700 uses a Service, the Message and the Wires 1706 used to communicate those messages are recorded. Note that Handler 1702 may direct outgoing messages to different ports 1708.

Thus, presented herein are a method, system and computer-readable medium for defining a message flow model of interactions between distributed services. In a preferred embodiment, the method includes the steps of: capturing uni-directional network-level message traffic between services in a network; identifying service end-points from information obtained from the uni-directional network-level message traffic; identifying message interactions of captured unidirectional network-level message traffic between identified service end-points; applying formal and informal interface definitions to the captured uni-directional network-level message traffic; categorizing each captured uni-directional network-level message traffic as being a public network-level message traffic or a private network-level message traffic; filtering the captured uni-directional network-level message traffic to filter out any formally defined captured uni-directional network-level message traffic; correlating message exchanges for filtered uni-directional network-level message traffic to identify a relationship between correlated message exchanges; and analyzing the network according to identified relationships between correlated message exchanges. Note that utilizing only unidirectional network-level message traffic in the modeling described herein allows the network analysis to isolate each message, thus permitting the message flow analysis described herein.

In one embodiment, the formal interface definitions are described using Web Service Definition Language (WSDL) resources for a given service end-point; and the informal interface definitions are text-based documentation of types of message traffic that are enabled for the service end-point. The method may further include the step of, in response to a set of messages failing to be correlated, defining a relationship among the set of messages as being coincidental. The uni-directional network-level message traffic may be captured by a network sniffer that is controlled by a network analyzing service, wherein the network analyzing service is exclusively devoted to analyzing the network. Furthermore, at least one of the informal interface definitions may be based on historical data that describes a second network message responding to a first network message to a service end-point.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for defining a message flow model of interactions between distributed services, the method comprising:
capturing uni-directional network-level message traffic between services in a network;
identifying service end-points from information obtained from the uni-directional network-level message traffic;
identifying message interactions of captured uni-directional network-level message traffic between identified service end-points;
applying formal interface definitions and informal interface definitions to the captured uni-directional network-level message traffic;
categorizing each captured uni-directional network-level message traffic as being either a public network-level message traffic or a private network-level message traffic;
filtering the captured uni-directional network-level message traffic to filter out any formally defined captured uni-directional network-level message traffic;
correlating message exchanges for filtered uni-directional network-level message traffic to determine a relationship between correlated message exchanges; and
analyzing the network according to identified relationships between correlated message exchanges.

2. The computer-implementable method of claim 1, wherein the relationship between correlated message exchanges is determined to be only one relationship from a group consisting of causation, correlation and coincidence.

3. The computer-implementable method of claim 1, wherein the formal interface definitions are described using Web Service Definition Language (WSDL) resources for a given service end-point.

4. The computer-implementable method of claim 1, wherein the informal interface definitions are text-based documentation of types of message traffic that are enabled for the service end-point.

5. The computer-implementable method of claim 1, further comprising:
in response to a set of messages failing to be correlated, defining a relationship among the set of messages as being coincidental.

6. The computer-implementable method of claim 1, wherein the uni-directional network-level message traffic is captured by a network sniffer that is controlled by a network analyzing service, wherein the network analyzing service is exclusively devoted to analyzing the network.

7. The computer-implementable method of claim 1, wherein at least one of the informal interface definitions is based on historical data that describes a second network message responding to a first network message to a service end-point.

8. The computer-implementable method of claim 1, wherein the network is a service network, and wherein the steps of claim 1 create a model that captures elements of the service network, the identified service end-points, the uni-directional network-level message traffic and message dependencies.

9. The computer-implementable method of claim 8, wherein the model is augmented with knowledge gained from formal resources, informal resources and user experience to describe a manner in which messages in the network service are related.

10. The computer-implementable method of claim 8, wherein the model includes handler logic descriptions that describe how a service manipulates and responds to messages received.

11. A system comprising:
a processor;
a data bus coupled to the processor;
a memory coupled to the data bus; and
a computer-usable medium embodying computer program code, the computer program code comprising instructions executable by the processor and configured for:
capturing unidirectional network-level message traffic between services in a network;
identifying service end-points from information obtained from the unidirectional network-level message traffic;
identifying message interactions of captured uni-directional network-level message traffic between identified service end-points;
applying formal and informal interface definitions to the captured uni-directional network-level message traffic;
categorizing each captured unidirectional network-level message traffic as being a public network-level message traffic or a private network-level message traffic;
filtering the captured uni-directional network-level message traffic to filter out any formally defined captured unidirectional network-level message traffic;
correlating message exchanges for filtered uni-directional network-level message traffic to identify a relationship between correlated message exchanges; and
analyzing the network according to identified relationships between correlated message exchanges.

12. The system of claim 11, wherein the formal interface definitions are described using Web Service Definition Language (WSDL) resources for a given service end-point.

13. A computer-usable medium embodying computer program code, the computer program code comprising computer executable instructions configured for:
capturing uni-directional network-level message traffic between services in a network;
identifying service end-points from information obtained from the uni-directional network-level message traffic;
identifying message interactions of captured unidirectional network-level message traffic between identified service end-points;
applying formal and informal interface definitions to the captured unidirectional network-level message traffic;
categorizing each captured uni-directional network-level message traffic as being a public network-level message traffic or a private network-level message traffic;
filtering the captured uni-directional network-level message traffic to filter out any formally defined captured unidirectional network-level message traffic;
correlating message exchanges for filtered uni-directional network-level message traffic to identify a relationship between correlated message exchanges; and
analyzing the network according to identified relationships between correlated message exchanges.

14. The computer-usable medium of claim 13, wherein the formal interface definitions are described using Web Service Definition Language (WSDL) resources for a given service end-point.

15. The computer-usable medium of claim 13, wherein the informal interface definitions are text-based documentation of types of message traffic that are enabled for the service end-point.

16. The computer-implementable method of claim 1, wherein the instructions are further configured for:
in response to a set of messages failing to be correlated, defining a relationship among the set of messages as being coincidental.

17. The computer-usable medium of claim 13, wherein the uni-directional network-level message traffic is captured by a network sniffer that is controlled by a network analyzing service, wherein the network analyzing service is exclusively devoted to analyzing the network.

18. The computer-usable medium of claim 13, wherein at least one of the informal interface definitions is based on historical data that describes a second network message responding to a first network message to a service end-point.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
